(19) United States
(12) Patent Application Publication
(10) Pub. No.: US 2009/0178298 A1
(43) Pub. Date: Jul. 16, 2009

(54) Device for fluid removal after laser scoring

(76) Inventors: Anatoli Anatolyevich Abramov, Painted Post, NY (US); Weiwei Luo, Painted Post, NY (US); Patrick Aaron Parks, Elmira, NY (US); Rashid A. Rahman, Horseheads, NY (US); Naiyue Zhou, Painted Post, NY (US)

Correspondence Address: CORNING INCORPORATED, SP-TI-3-1, CORNING, NY, 14831, US

(21) Appl. No.: 12/008,892

(22) Filed: Jan. 15, 2008

(51) Int. Cl. F26B 21/00

(52) U.S. Cl. 34/523

(57) ABSTRACT

An apparatus for drying a surface of a substrate during laser scoring. During the laser scoring process, a narrow cooling liquid jet follows the laser beam to create and propagate a partial vent. Precision of the scoring and overall stability of the process depend upon the accuracy of the alignment of the beam and the fluid stream. In one aspect, the apparatus has a conduit with at least one interior chamber in communication with at least one nozzle orifice. The conduit is configured to be in communication with a pressurized gas source to introduce the pressurized gas into the chamber. The pressurized gas forms a curtain of gas that is used to clean the cooling fluid therefrom the surface of the substrate.

### FIELD OF THE INVENTION

The field of this invention relates generally to laser scoring of glass substrates, and more particularly to a device for the removal of cooling fluid after laser scoring.

### BACKGROUND OF THE INVENTION

In the production of LCD glass, it becomes necessary to cut the glass substrate. In conventional separation of glass by mechanical scribing and breaking, microcracks form along the edges, which can develop into macrocracks if the edge is not treated further. The use of a laser to score the surface of the substrate helps to avoid microcracking and significantly improves the quality of the laser scored edges. It has been calculated that the edge strength of laser-cut brittle materials is up to 30% better than that obtained by conventional methods. In addition, the bending strength of the laser-cut material can be improved by up to 100%.

In operation, heat induced laser separation is a no-contact method which produces no particles and, due to the flexibility of orienting the laser relatively to the glass, allows for the production of virtually any cutting contour. Typically, an area of the glass surface is heated by a CO₂ laser working in the infrared spectral range. The laser beam moves relative to the glass and the glass surface exposed to the laser is subsequently cooled from an optimal distance. In one aspect, the coolant is applied so that the local surface along the “heated” cutting line is suddenly cooled.

Tensile stresses generated during the cooling process propagate the initial flow on the glass surface, which forms a partial vent. While the use of many types of coolants are possible, in the case of the scoring glasses with very low expansion coefficients, such as LCD substrates, the coolant is generally water or a water aerosol. In this aspect, much of the water is evaporated during the process by heat generated by the laser beam. However, in some applications, some coolant remains on the substrate in the area around the score line, which has to be removed to ensure that the surface remains dry and clean.

What is needed is a device that is non-contact and generally does not interfere with the coolant jet or cause a deflection or vibration of the glass. Further, a device is needed that is very efficient in containing and removing the coolant at a high speed of relative motion of the glass surface.

### SUMMARY OF THE INVENTION

The invention relates to an apparatus for drying a surface of a substrate during laser scoring. In one embodiment, a narrow cooling liquid jet follows the laser beam to create and propagate a partial vent during the laser scoring process. Generally, the precision of the scoring and overall stability of the process depend upon the accuracy of the alignment of the laser beam and the liquid jet. It is contemplated that the removal of the fluid from the glass surface should not affect the position and the stability of the cooling liquid jet.

In one aspect, the apparatus comprises a conduit with at least one interior chamber in fluid communication with at least one nozzle orifice. The conduit is configured to be in communication with a pressurized gas source to introduce the pressurized gas into the interior chamber. In one aspect, the conduit has a first end portion and a second end portion that are connected to respective ends of a middle portion that can be positioned between the first and second end portions. In another aspect, the conduit can be shaped such that the respective first end portion, second end portion, and middle portion are not positioned co-axial relative to each other.

### DETAILED DESCRIPTION OF THE FIGURES

These and other features of the preferred embodiments of the invention will become more apparent in the detailed description in which reference is made to the appended drawings wherein:

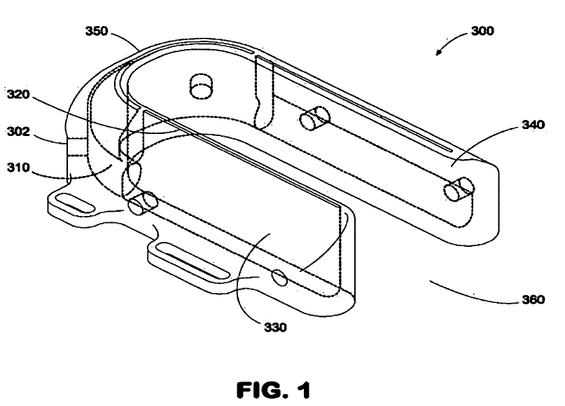

FIG. 1 is a partially transparent perspective view of one embodiment of an apparatus for drying a surface of a substrate according to the present invention.

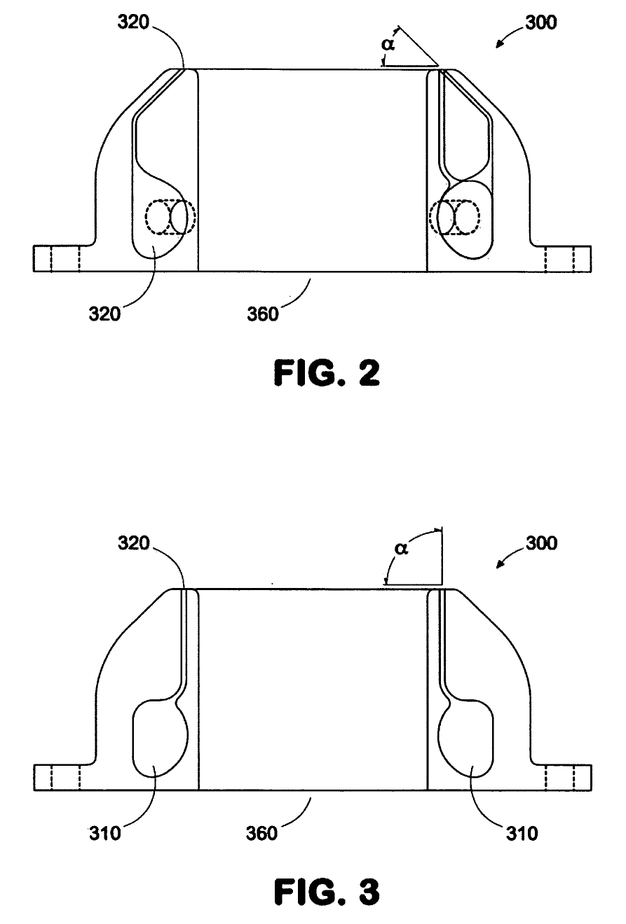

FIG. 2 is front cut-away elevational view of the drying apparatus of FIG. 1, showing a plurality of interior chambers, a plurality of nozzle orifices, and an exit angle.

FIG. 3 is a front cut-away elevational view of the drying apparatus of FIG. 1, showing an exit angle of about 90°.

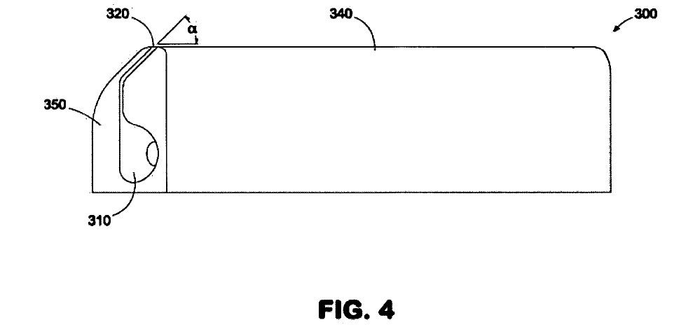

FIG. 4 is a left cut-away elevational view of the drying apparatus of FIG. 1, showing an interior chamber in a middle portion of the apparatus.

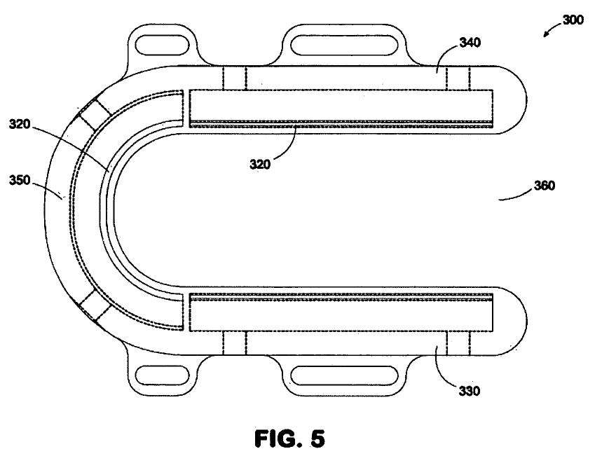

FIG. 5 is a top plan view of the drying apparatus of FIG. 1.

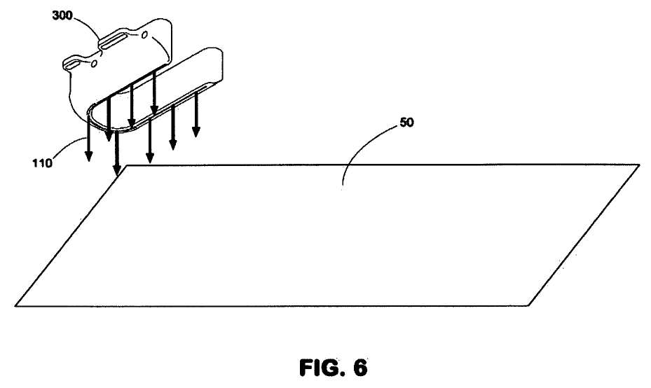

FIG. 6 is a perspective view of one embodiment of the drying apparatus of FIG. 1, illustrating a curtain of gas being emitted from the apparatus toward a substrate.

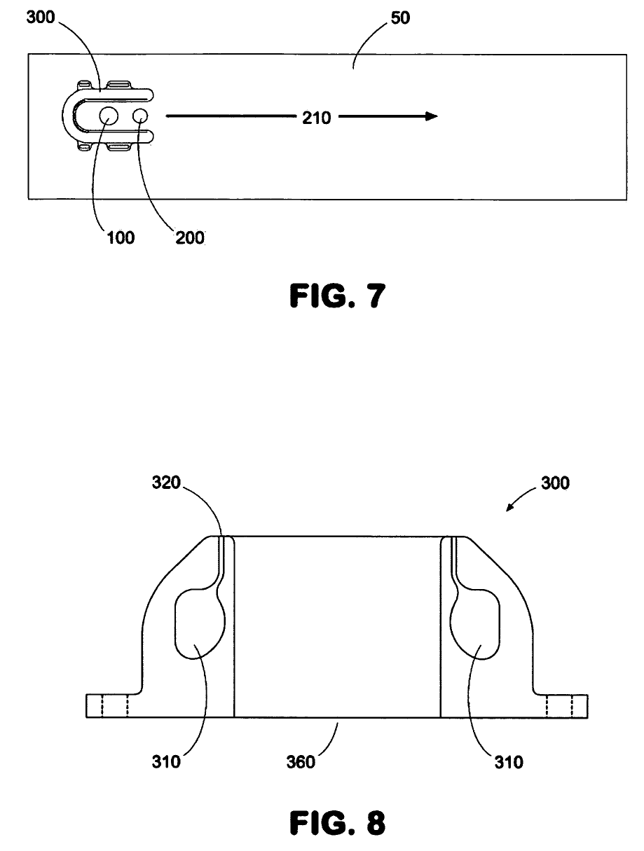

FIG. 7 is a top plan view of the apparatus of FIG. 1 positioned relative to a laser beam and a liquid jet.

FIG. 8 is a front cut-away elevational view of the drying apparatus of FIG. 1, showing a shortened elongated nozzle orifice.

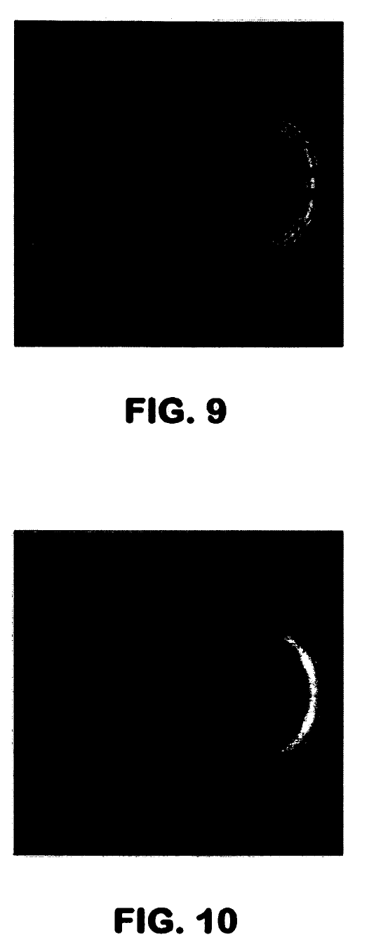

FIG. 9 is a diagrammatical view of a contour of static pressure on a substrate illustrating the apparatus of FIG. 3 at a distance of about 4 mm from the substrate.

FIG. 10 is a diagrammatical view of a contour of static pressure on a substrate illustrating the apparatus of FIG. 3 at a distance of about 10 mm from the substrate.

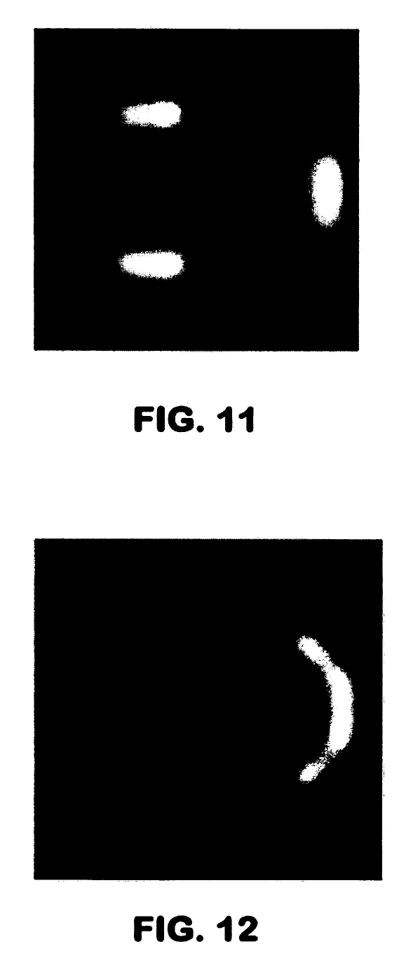

FIG. 11 is a diagrammatical view of a contour of static pressure on a substrate illustrating the apparatus of FIG. 3 at a distance of about 20 mm from the substrate.

FIG. 12 is a diagrammatical view of a contour of static pressure on a substrate illustrating the apparatus of FIG. 8 at a distance of about 20 mm from the substrate.

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a nozzle orifice” can include two or more such nozzle orifices unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The invention relates to an apparatus for drying a surface of a substrate 50 during laser scoring. During the laser scoring process, a narrow cooling liquid jet 100 follows the laser beam 200 to create and propagate a partial vent. Precision of the scoring and overall stability of the process depend upon the accuracy of the alignment of the beam and the fluid stream. Therefore, removal of the fluid from the surface should not affect the position and the stability of the cooling liquid jet 100. While, in a preferred embodiment, the laser beam 200 and drying apparatus are being transferred substantially along the scoring path 210 while the substrate 50 remains stationary, it is contemplated that the substrate is transferred while the laser remains stationary. Additionally, in one aspect the fluid being propelled from the cooling liquid jet is water. However, other cooling fluids are contemplated, for example and not meant to be limiting, liquid nitrogen, air-water mix, ethyl alcohol mixed with deionized water, or carbon dioxide.

In one aspect, the apparatus comprises a conduit 300 with at least one interior chamber 310. In communication with the chamber 310 is at least one nozzle orifice 320 therein a portion of the exterior surface 302 of the conduit 300. The conduit is configured to be in communication with a pressurized gas source to introduce the pressurized gas into the chamber. In one aspect, the conduit has a first end portion 330, a second end portion 340, and a middle portion 350 that is substantially therebetween the first and second end portions. In another aspect, the conduit is shaped such that the first end portion 330, second end portion 340, and middle portion 350 are not co-linear. As such, in one exemplary aspect, the conduit 300 is substantially u-shaped. In yet another exemplary aspect, the conduit is substantially c-shaped. In still another exemplary aspect, the conduit is substantially v-shaped. However, other conduit shapes are also contemplated.

It can be appreciated that there may be one nozzle orifice 320 or a plurality of nozzle orifices configured to propel a laminar flow of pressurized gas received by the interior chamber toward the surface of the substrate in a manner which forms a curtain 110 of gas that substantially conforms to the shape of the conduit 300. By “curtain” it is meant that the gas forms a laminar partition. This curtain 110 may have continuous as well as intermittent sections, or it may be substantially continuous or substantially intermittent.

In one aspect, there is a plurality of interior chambers. For example, and not meant to be limiting, there may be three interior chambers 310, where at least one of the interior chambers is defined in the middle portion of the conduit, at least one of the interior chambers is defined in the first end portion, and at least one of the interior chambers is defined in the second end portion. Each chamber 310 may be configured to be in communication with a pressurized gas source, or they may be in communication with each other while one of the respective chambers is in communication with the pressurized gas source. In another aspect, where each of the chambers is configured to be in communication with a pressurized gas source, the flow of pressurized gas to each of the chambers is individually controllable. In one exemplary aspect, the pressurized gas comprises air, however, other gases are contemplated.

In another aspect, the apparatus comprises at least three nozzle orifices. One of the nozzle orifices is defined in an exterior surface 302 of the middle portion and is in communication with the interior chamber 310 defined in the middle portion of the conduit. Another of the nozzle orifices is defined in an exterior surface of the first end portion of the conduit and is in communication with the interior chamber defined in the first end portion of conduit. The third nozzle orifice 320 is defined in an exterior surface of the second end portion of the conduit 300 and is in communication with the interior chamber defined in the second end portion of conduit. As illustrated in the figures, in one aspect, the respective exterior surfaces in which the first, second, and third nozzle orifices are defined are substantially coplanar.

In another aspect, the nozzle orifices are each formed as elongated slits defined in the generally coplanar surface portions of the conduit. As mentioned above, each nozzle orifice is configured to direct a laminar flow of pressurized gas toward the substrate surface. In one exemplary aspect, the nozzle orifice is configured to direct the laminar flow of pressurized gas toward the substrate 50 surface at an exit angle a in the range of from about 30° to about 90°. In another aspect, the nozzle orifice is configured to direct the laminar flow of pressurized gas toward the substrate surface at an exit angle a in the range of from about 30° to about 45°. In still another aspect, the nozzle orifice is configured to direct the laminar flow of pressurized gas toward the substrate 50 surface at an exit angle in the range of from about 75° to about 90°. In one aspect, exit angle a from the nozzle is complimentary with the angle of incidence relative to the substrate surface.

In addition to the exit angles, the specific geometries of the chambers and the nozzle orifices, as well as the shape of the exterior surface, can have a substantial impact on the performance of the fluid removal apparatus. Prototype testing of at least two aspects of the present invention has been completed. In one aspect, as shown in FIG. 1, the nozzle orifices comprise an elongated slit. The orifice was tested with several exit angles in the range from about 30° to about 90°. As a result, the aspect with an exit angle from about 75° to about 90° provided the minimal effect on the cooling fluid jet, while the smaller exit angle provided a better cleaning effect, but more interference with the cooling fluid jet. As can be expected, FIGS. 9-11 illustrate that the static pressure on the substrate decreases as the apparatus is positioned further away from the substrate. In these figures, the bright portions represent areas of higher static pressure. FIG. 9 shows the contour of the static pressure when the apparatus is at 4 mm; FIG. 10 illustrates it at 10 mm; and FIG. 11 shows it at 20 mm. As can be seen, the contour of the static pressure on the substrate is less defined as the device is positioned further away from the substrate.

In another aspect, tests were conducted on a fluid removal apparatus as illustrated in FIG. 8, where the nozzle orifice comprises a shorter elongated slit than the apparatus of FIGS. 2 and 3. This geometry reduces the disturbance of the gas flow induced by the internal walls of the chambers, which resulted in less turbulent gas flow at a great distance from the fluid removal apparatus. This is illustrated in FIG. 12, which shows the contour of the static pressure on the substrate when the device in FIG. 8 is positioned at around 25 mm. As can be seen, this device appeared to be more efficient at longer ranges (i.e., 25 mm) than the device of FIGS. 2 and 3 as evidenced by FIG. 12 versus FIG. 11. It was also shown that, at distances closer to the substrate (i.e., 10 mm), the device comprising the longer elongated slits was more efficient than the device with the shorter elongated slits.

Referring now to FIG. 7, the cooling liquid source substantially follows the scoring path 210 of the laser beam 200. In one aspect, the conduit at least substantially envelops the cooling liquid source positioned in the cavity 360 formed by the respective first and second end portions and the middle portion 350 of the conduit. In this aspect, as can be appreciated, the curtain of gas 110 partially surrounds the cooling liquid source and, when the cooling liquid source moves, the curtain of gas substantially cleans the substrate of the cooling liquid and prevents it from further wetting the substrate. In one aspect, in use, the apparatus is positioned from about 0.5 mm to about 50 mm away from the substrate. In another aspect, the apparatus, in use, is positioned from about 1 mm to about 12 mm away from the substrate.

The conduit, in one aspect, may comprise a number of sufficiently rigid and durable materials. For example, and not meant to be limiting, the conduit may comprise steel, aluminum, brass, nickel, or other metal alloy, as well as polymers, and the like. In yet another aspect, the exterior surface is slightly rounded, as shown in FIG. 1, which may have a beneficial impact on producing a Coanda effect to direct some of the external air flow in the direction of the curtain of gas. Some of the surface features for the conduit that have been shown to be beneficial include a low surface roughness (about 32 or below in the AA roughness scale), the ability to withstand typical operating environment temperatures for a laser scoring process, and corrosion resistance. One with ordinary skill in the art can appreciate the variety of materials that may or may not be suitable for the conduit.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

We claim:

1. An apparatus for drying a surface of a substrate during laser scoring, comprising
a conduit having an exterior surface and defining at least one interior chamber and at least one nozzle orifice therein a portion of the exterior surface, wherein the at least one nozzle orifice is in communication with the at least one chamber, and wherein the conduit has a first end portion, a second end portion, and a middle portion substantially therebetween the first and second end portions, wherein the conduit is shaped such that the first end portion, second end portion, and middle portion are not co-linear;
wherein the at least one nozzle orifice is configured to propel a laminar flow of pressurized gas received by the at least one interior chamber toward the surface of the substrate in a manner which forms a curtain of gas that substantially conforms to the shape of the conduit.

2. The apparatus of claim 1, wherein the conduit is generally U-shaped.

3. The apparatus of claim 1, wherein the conduit is generally V-shaped.

4. The apparatus of claim 1, wherein the conduit is generally C-shaped.

5. The apparatus of claim 1, wherein the at least one interior chamber comprises a plurality of interior chambers.

6. The apparatus of claim 1, wherein the at least one interior chamber comprises at least three interior chambers and wherein at least one of the interior chambers is defined in the middle portion of the conduit, at least one of the interior chambers is defined in the first end portion of the conduit, and at least one of the interior chambers is defined in a second end portion of the conduit

7. The apparatus of claim 6, wherein the at least one nozzle orifice comprises at least three nozzle orifices, and wherein a first one of the plurality of nozzle orifices is defined in an exterior surface of the middle portion and is in communication with the at least one interior chamber defined in the middle portion of the conduit, a second one of the plurality of nozzle orifices is defined in an exterior surface of the first end portion of the conduit and is in communication with the at least one interior chamber defined in the first end portion of the conduit, and a third one of the plurality of nozzle orifices is defined in an exterior surface of the second end portion of the conduit and is in communication with the at least one interior chamber defined in the second end portion of the conduit

8. The apparatus of claim 1, wherein the at least one nozzle orifice comprises a plurality of nozzle orifices.

9. The apparatus of claim 1, wherein the at least one nozzle orifice comprises at least three nozzle orifices, and wherein a first one of the plurality of nozzle orifices is defined in an exterior surface of the middle portion, a second one of the plurality of nozzle orifices is defined in an exterior surface of the first end portion of the conduit, and a third one of the plurality of nozzle orifice is defined in an exterior surface of the second end portion of the conduit, wherein the respective exterior surfaces in which the first, second, and third nozzle orifices are defined are substantially co-planar.

10. The apparatus of claim 9, wherein the conduit is substantially U-shaped and wherein the first, second, and third nozzle orifices are each formed as elongated slits defined in the substantially coplanar surface portions of the respective middle portion and pair of opposed end portions of the conduit.

11. The apparatus of claim 1, wherein each of the at least one interior chambers is in communication with a pressurized gas source and wherein a flow of pressurized gas to each of the at least one interior chambers is individually controllable.

12. The apparatus of claim 1, wherein the at least one nozzle orifice is configured to direct the laminar flow of pressurized gas toward the substrate surface at an exit angle in the range of from about 30° to about 90°.

13. The apparatus of claim 12, wherein the at least one nozzle orifice is configured to direct the laminar flow of pressurized gas toward the substrate surface at an exit angle in the range of from about 30° to about 45°.

14. The apparatus of claim 12, wherein the at least one nozzle orifice is configured to direct the laminar flow of pressurized gas toward the substrate surface at an exit angle in the range of from about 75° to about 90°.

15. The apparatus of claim 1, wherein the conduit at least substantially envelops a cooling liquid source positioned in a cavity formed by the respective first and second end portions and the middle portion of the conduit.
